(19) United States
(12) Patent Application Publication
(10) Pub. No.: US 2026/0208474 A1
(43) Pub. Date: Jul. 23, 2026

(54) PRESS DEVICE AND PRESS METHOD

(71) Applicant: HONDA MOTOR CO., LTD., Tokyo (JP)

(72) Inventors: Satoshi AOKI, Saitama (JP); Hirotaka Sano, Saitama (JP); Yayoi Matsushita, Saitama (JP); Tsugio Masuda, Saitama (JP)

(73) Assignee: HONDA MOTOR CO., LTD., Tokyo (JP)

(21) Appl. No.: 19/428,380

(22) Filed: Dec. 22, 2025

(30) Foreign Application Priority Data
Dec. 26, 2024 (JP) 2024-229763

(51) Int. Cl. B32B 37/00; B32B 38/00; H01M 10/04

(52) U.S. Cl. CPC B32B 37/025; B32B 37/0053; B32B 38/1875; H01M 10/0404; B32B 2307/202; B32B 2457/10

(57) ABSTRACT

A press device is configured to transfer a transfer body to a substrate sheet. The press device has a transfer sheet roll body around which a transfer sheet including the transfer body is wound, a transfer roller which transfers the transfer body to the substrate sheet, and an expander roll which applies a tension to the transfer sheet. The expander roll is disposed upstream of the transfer roller in a conveyance direction of the substrate sheet, and applies the tension to the transfer sheet in a width direction.

### CROSS-REFERENCE TO RELATED APPLICATIONS

This application is based on and claims priority under 35 USC 119 from Japanese Patent Application No. 2024-229763 filed on Dec. 26, 2024, the entire content of which is incorporated herein by reference.

### TECHNICAL FIELD

The present disclosure relates to a press device for producing a solid-state battery, and a press method.

### BACKGROUND ART

In recent years, researches and developments have been conducted on a secondary battery which contributes to improvement in energy efficiency in order to allow more people to have access to affordable, reliable, sustainable and advanced energy.

In related art, as a method for producing a solid-state battery, there is known a production method of pressing a positive electrode layer, a solid electrolyte layer, and a negative electrode layer with a roll (for example, JP2023-085663A).

In the method for producing the solid-state battery described in JP 2023-085663A, a sheet on which the solid electrolyte layer is provided is pressed onto the positive electrode layer to transfer the solid electrolyte layer to the positive electrode layer, but transfer accuracy of the solid electrolyte layer may decrease.

### SUMMARY OF INVENTION

The present disclosure provides a press device and a press method that enable to accurately transfer a solid electrolyte layer to a positive electrode layer. This further contributes to improvement in energy efficiency.

A first aspect of the present disclosure is to a press device configured to transfer a transfer body to a substrate sheet, the press device including:
a transfer sheet roll body around which a transfer sheet including the transfer body is wound;
a transfer roller configured to transfer the transfer body to the substrate sheet; and
an expander roll configured to apply a tension to the transfer sheet, in which
the expander roll is disposed upstream of the transfer roller in a conveyance direction of the substrate sheet, and applies the tension to the transfer sheet in a width direction.

A second aspect of the present disclosure is to a press method of transferring a transfer body to a substrate sheet, the press method including:
applying a tension, in a width direction orthogonal to a conveyance direction, to a
transfer sheet unwound from a transfer sheet roll body; transferring the transfer body, in a state where the tension is applied, to the substrate sheet; and
pressing the substrate sheet to which the transfer sheet is transferred at a higher pressure than that in the transferring the transfer body.

According to the aspects of the present disclosure, it is possible to accurately transfer a solid electrolyte layer to a positive electrode layer. This can further contribute to improvement in energy efficiency.

### BRIEF DESCRIPTION OF DRAWINGS

Exemplary embodiment(s) of the present invention will be described in detail based on the following figures, wherein:

FIG. 1 is a cross-sectional view showing an example of a solid-state battery 1;

FIG. 2 shows an example of a press device 100 for producing the solid-state battery 1 according to an embodiment;

FIG. 3 shows a part of the press device 100, and particularly, shows an example of transferring a first solid electrolyte layer SE1;

FIG. 4 is a schematic diagram showing an example of an expander roll 110;

FIG. 5 shows a part of the press device 100, and particularly, shows an example of transfer by an intermediate layer transfer roller 150 and a negative electrode transfer roller 160;

FIG. 6 is a flowchart showing an example of a press method using the press device 100;

FIG. 7 is a schematic diagram showing another example of the expander roll 110; and

FIG. 8 is a schematic diagram showing still another example of the expander roll 110.

### DESCRIPTION OF EMBODIMENTS

Hereinafter, an embodiment will be described with reference to the accompanying drawings. A press device 100 in the embodiment is used for producing a solid-state battery 1. First, a configuration of the solid-state battery 1 will be described.

### Solid-State Battery

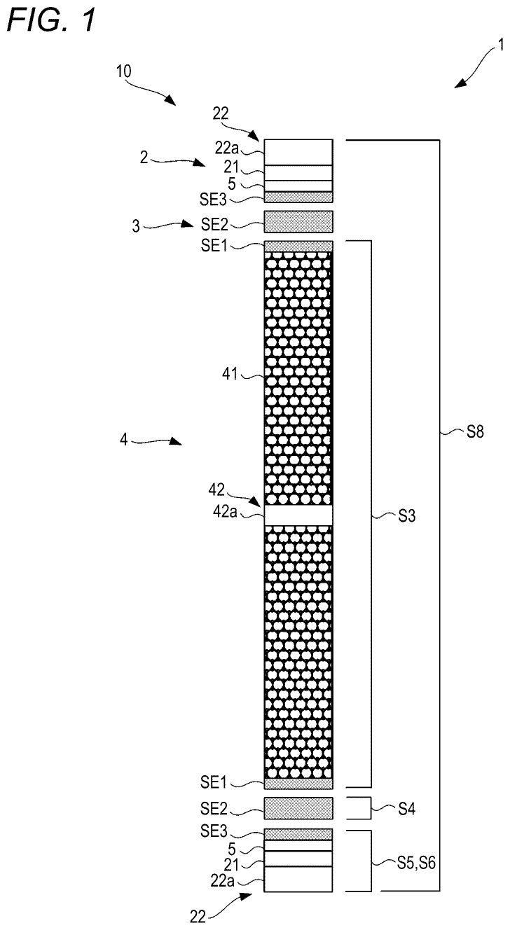

FIG. 1 is a schematic diagram showing an example of the solid-state battery 1. The solid-state battery 1 is an all-solid-state battery including an electrode 10 in which a negative electrode layer 2, a solid electrolyte layer 3, and a positive electrode layer 4 are laminated. In the embodiment, as shown in FIG. 1, a structure in which the negative electrode layer 2, the solid electrolyte layer 3, the positive electrode layer 4, the solid electrolyte layer 3, and the negative electrode layer 2 are laminated in this order will be described as a laminated structure of the solid-state battery 1. The structure of the solid-state battery 1 is not limited to the above. The solid-state battery 1 may have, for example, a configuration that can be used for a solid-state battery such as an exterior body in addition to the electrode 10 shown in FIG. 1.

The solid electrolyte layer 3 in the solid-state battery 1 includes at least a first solid electrolyte layer SE1 disposed on a side of the positive electrode layer 4 and a negative electrode side solid electrolyte layer SE3 disposed on a side of the negative electrode layer 2. The solid electrolyte layer 3 may include a second solid electrolyte layer SE2 disposed adjacent to the first solid electrolyte layer SE1. In the embodiment, the solid electrolyte layer 3 will be described as being constituted by the above three layers. An intermediate layer 5 may be disposed as desired between the negative electrode layer 2 and the solid electrolyte layer 3.

The solid-state battery 1 is not particularly limited, and may be a lithium ion solid-state secondary battery or a lithium metal secondary battery.

### Negative Electrode Layer

The negative electrode layer 2 includes a negative electrode active material layer 21 and a negative electrode current collector layer 22. The negative electrode active material layer 21 is not particularly limited and may be made of a material that can be used as a negative electrode active material of the solid-state battery 1. Examples of the negative electrode active material constituting the negative electrode active material layer 21 include lithium metal, lithium alloys, silicon-based active materials such as Si and Si alloys, lithium transition metal oxides such as lithium titanate (Li₄Ti₅O₁₂), transition metal oxides such as TiO₂, Nb₂O₃, and WO₃, metal sulfides, metal nitrides, carbon materials such as graphite, soft carbon, and hard carbon, and metal indium.

In addition to the above, the negative electrode active material layer 21 may contain a material that can be contained in the negative electrode active material layer 21 of the solid-state battery 1. Examples of the material include a solid electrolyte, a conductive assistance, and a binder. Examples of the solid electrolyte include the same solid electrolytes as those contained in the solid electrolyte layer 3 to be described later. Examples of the conductive assistance include carbon black, natural graphite, carbon fiber, and carbon nanotube. Examples of the binder include nitrile polymers, polyester polymers, acrylic acid polymers, cellulose polymers, styrene polymers, styrene butadiene polymers, vinyl acetate polymers, urethane polymers, and fluoroethylene polymers.

The negative electrode current collector layer 22 is not particularly limited and may be made of copper, nickel, stainless steel, or the like. Examples of a shape of the negative electrode current collector layer 22 include a foil shape, a plate shape, a mesh shape, a nonwoven fabric shape, and a foam shape. In the embodiment, the negative electrode current collector layer 22 is formed of a negative electrode current collecting foil 22a.

### Solid Electrolyte Layer

The solid electrolyte layer 3 is formed between the negative electrode layer 2 and the positive electrode layer 4. In the embodiment, the solid electrolyte layer 3 has a structure in which the first solid electrolyte layer SE1 disposed in contact with the positive electrode layer, the second solid electrolyte layer SE2, and the negative electrode side solid electrolyte layer SE3 disposed on the side of the negative electrode layer 2 are laminated in this order.

The first solid electrolyte layer SE1 is disposed in contact with a positive electrode active material layer 41 in the positive electrode layer 4. A solid electrolyte constituting the first solid electrolyte layer SE1 is not particularly limited and may be a material that can be used as an electrolyte for a solid-state battery. Examples thereof include inorganic solid electrolytes such as sulfide solid electrolytes, oxide solid electrolytes, halide solid electrolytes, and lithium-containing salts, and polymer-based solid electrolytes such as polyethylene oxide. The above-described solid electrolytes may be used alone or two or more thereof may be used in combination.

The first solid electrolyte layer SE1 contains a binder in addition to the solid electrolyte material. As the binder, the same material as the binder that can be contained in the negative electrode active material layer 21 can be used. A content of the binder with respect to mass of the entire first solid electrolyte layer SE1 in the first solid electrolyte layer SE1 is equal to or greater than a content of the binder with respect to mass of the entire second solid electrolyte layer SE2 in the second solid electrolyte layer SE2. An upper limit of the content of the binder in the first solid electrolyte layer SE1 is, for example, 25 mass %. The content of the binder in the first solid electrolyte layer SE1 is preferably 10 mass % to 30 mass %. Accordingly, it is easier for the first solid electrolyte layer SE1 to extend following the positive electrode layer 4 when the positive electrode layer 4 is pressed (stamped).

In addition to the solid electrolyte material and the binder, the first solid electrolyte layer SE1 may contain a material that can be used for a solid electrolyte layer of a solid-state battery.

A thickness of the first solid electrolyte layer SE1 (a length of each layer in a lamination direction) is preferably less than a thickness of the second solid electrolyte layer SE2. The thickness of the first solid electrolyte layer SE1 is preferably, for example, 3 μm to 15 μm.

The second solid electrolyte layer SE2 is a layer disposed as desired and is disposed adjacent to the first solid electrolyte layer SE1. A solid electrolyte material constituting the second solid electrolyte layer SE2 is not particularly limited and may be the same material as the solid electrolyte material constituting the first solid electrolyte layer SE1. Similarly to the first solid electrolyte layer SE1, the second solid electrolyte layer SE2 may contain a binder or the like in addition to the solid electrolyte material. A content of the binder in the second solid electrolyte layer SE2 is equal to or less than the content of the binder in the first solid electrolyte layer SE1. The content of the binder in the second solid electrolyte layer SE2 is preferably, for example, 10 mass % to 30 mass %. Accordingly, energy density of the solid-state battery 1 can be improved. The second solid electrolyte layer SE2 may include a support. The support may be a three-dimensional structure such as a mesh, a woven fabric, a nonwoven fabric, an embossed body, a punched body, an expanded body, or foam. The second solid electrolyte layer SE2 may not contain the support.

The thickness of the second solid electrolyte layer SE2 (the length of each layer in the lamination direction) is preferably greater than the thickness of the first solid electrolyte layer SE1. The thickness of the second solid electrolyte layer SE2 is preferably greater than a thickness of the negative electrode side solid electrolyte layer SE3 to be described later. The thickness of the second solid electrolyte layer SE2 is preferably, for example, 10 μm to 50 μm.

The negative electrode side solid electrolyte layer SE3 is disposed on the side of the negative electrode layer 2. The negative electrode side solid electrolyte layer SE3 is disposed adjacent to the negative electrode layer 2. When the solid-state battery 1 includes the intermediate layer 5 as shown in FIG. 1, the negative electrode side solid electrolyte layer SE3 may be disposed adjacent to the intermediate layer 5.

A solid electrolyte material constituting the negative electrode side solid electrolyte layer SE3 is not particularly limited and may be the same material as the solid electrolyte material constituting the first solid electrolyte layer SE1. A content of the binder in the negative electrode side solid electrolyte layer SE3 is preferably, for example, 1.3 mass % to 8.7 mass %. In terms of vol %, the content of the binder in the negative electrode side solid electrolyte layer SE3 is preferably, for example, 2.7 vol % to 10 vol %. The content of the binder in the negative electrode side solid electrolyte layer SE3 is less than the content of the binder in the first solid electrolyte layer SE1.

The thickness of the negative electrode side solid electrolyte layer SE3 (the length of each layer in the lamination direction) is preferably less than the thickness of the second solid electrolyte layer SE2. The thickness of the negative electrode side solid electrolyte layer SE3 is preferably, for example, 3 μm to 8.5 μm.

### Positive Electrode Layer

The positive electrode layer 4 includes the positive electrode active material layer 41 and a positive electrode current collector layer 42. In the embodiment, the positive electrode layer 4 has a configuration in which two positive electrode active material layers 41 are laminated on both surfaces of one positive electrode current collector layer 42. The configuration of the positive electrode layer 4 is not limited to the above, and a configuration may be adopted in which one positive electrode active material layer 41 is laminated on one surface of one positive electrode current collector layer 42.

The positive electrode active material layer 41 is not particularly limited and may be made of a material that can be used as a positive electrode active material of a solid-state battery. Examples of the positive electrode active material constituting the positive electrode active material layer 41 include layered positive electrode active material particles such as LiCoO₂, LiNiO₂, LiCoₓNi_{y}Mn_{z}O₂ (x+y+z=1), LiVO₂, and LiCrO₂, spinel-type positive electrode active materials such as LiMn₂O₄, Li(Ni_{0.25}Mn_{0.75})₂O₄, LiCoMnO₄, and Li₂NiMn₃O₈, olivine-type positive electrode active materials such as LiCoPO₄, LiMnPO₄, and LiFePO₄, solid solution oxides (Li₂MnO₃—LiMO₂ (M=Co, Ni, or the like), conductive polymers such as polyaniline and polypyrrole, sulfides such as Li₂S, CuS, Li—Cu—S compounds, TiS₂, FeS, MoS₂, and Li—Mo—S compounds, and mixtures of sulfur and carbon. The positive electrode active material may contain one of the above materials or may contain two or more of the above materials.

The positive electrode active material layer 41 may include a binder or the like. A content of the binder in the positive electrode active material layer 41 is preferably 0.5 mass % to 5 mass %. Preferably, the content may be 2.56 mass %. A thickness of the positive electrode active material layer 41 (the length of each layer in the lamination direction) is preferably, for example, 80 μm to 100 μm. Accordingly, a battery capacity of the solid-state battery 1 can be improved.

The positive electrode current collector layer 42 is not particularly limited and may be made of, for example, aluminum, stainless steel, or conductive carbon (for example, graphite or carbon nanotube). Examples of a shape of the positive electrode current collector layer 42 include a foil shape, a plate shape, a mesh shape, a nonwoven fabric shape, and a foam shape. In the embodiment, the positive electrode current collector layer 42 is formed of a positive electrode current collecting foil 42a.

### Intermediate Layer

The intermediate layer 5 is disposed between the negative electrode layer 2 and the solid electrolyte layer 3. For example, when the solid-state battery 1 is a lithium metal battery, the intermediate layer 5 has a function of uniformly depositing lithium metal. Therefore, an interface between the intermediate layer 5 and the solid electrolyte layer 3 is stabilized. When the solid-state battery 1 is a lithium metal secondary battery having the intermediate layer 5, the solid-state battery 1 may be an anode-free battery where the negative electrode active material layer 21 is not present at the time of initial charge. In this case, a lithium metal layer as the negative electrode active material layer 21 is formed after initial charge and discharge.

A material constituting the intermediate layer 5 is not particularly limited, and examples thereof include amorphous carbon and a metal that can alloy with lithium. Examples of the metal that can alloy with lithium include tin (Sn), silicon (Si), zinc (Zn), magnesium (Mg), gold (Au), platinum (Pt), palladium (Pd), silver (Ag), aluminum (Al), bismuth (Bi), and antimony (Sb). The metal that can alloy with lithium may be nanoparticles. Examples of the amorphous carbon include carbon black such as acetylene black, furnace black, and Ketjen black, coke, and activated carbon. The amorphous carbon may be graphitizable carbon (soft carbon), non-graphitizable carbon (hard carbon), carbon nanotube (CNT), fullerene, or graphene. The intermediate layer may contain a binder in addition to the above materials.

### Press Device

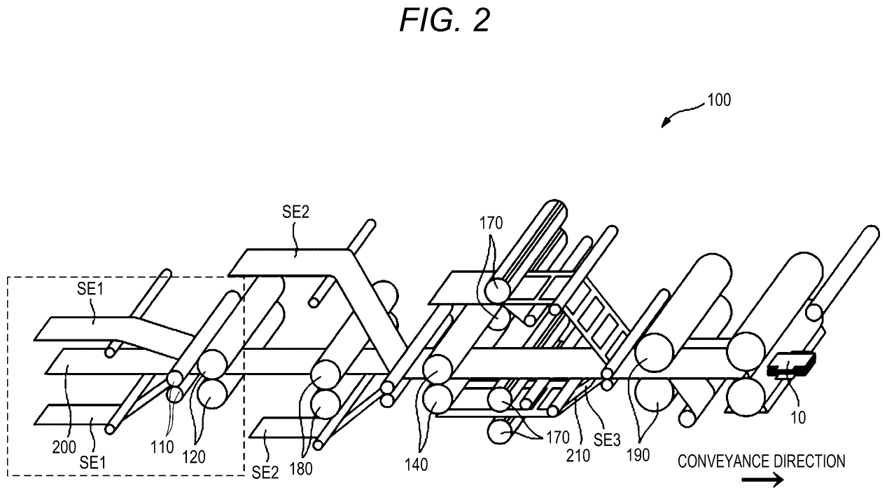

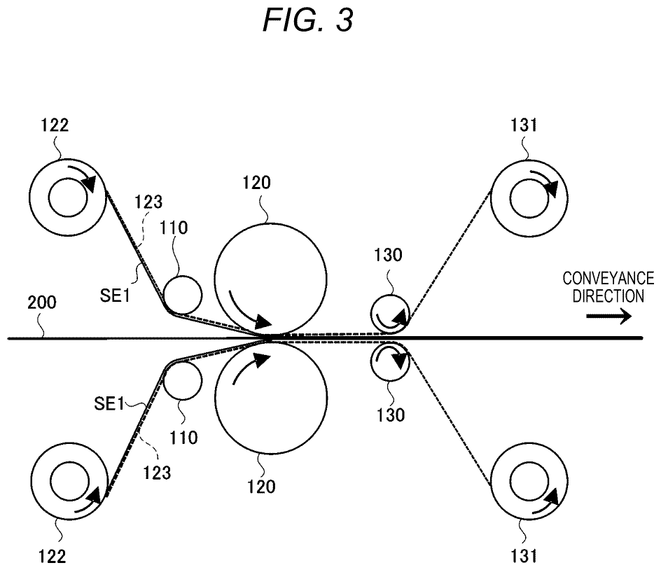

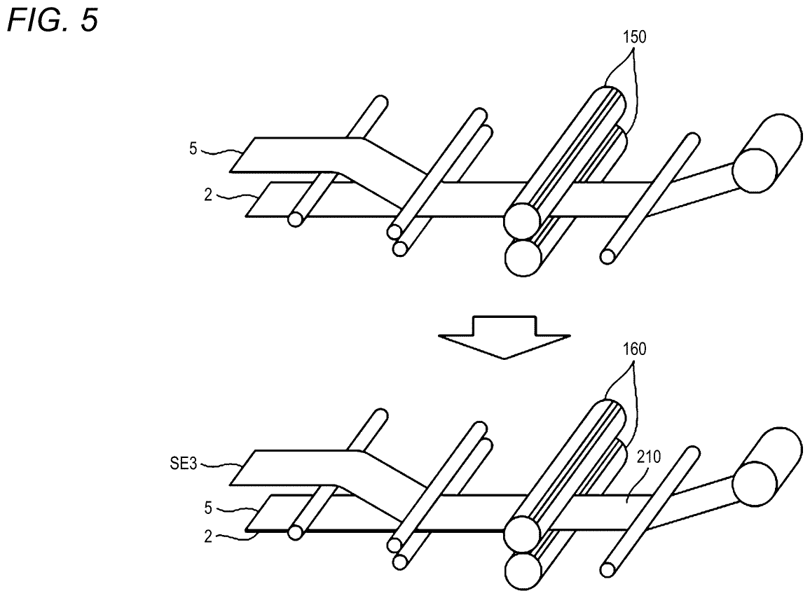

Next, a configuration of the press device 100 for producing the solid-state battery 1 configured as described above will be described. FIG. 2 shows an example of the press device 100 in the embodiment. The press device 100 includes, as main components, an expander roll 110, a first positive electrode transfer roller 120, a peeling roller 130 (see FIG. 3), a second positive electrode transfer roller 140, an intermediate layer transfer roller 150 (see FIG. 5), a negative electrode transfer roller 160 (see FIG. 5), a negative electrode sheet member lamination roller 170, a positive electrode press roll 180, and an integration press roll 190. The press device 100 continuously produces the solid-state battery 1 while feeding a positive electrode sheet member 200 in one direction by each of these rollers. FIG. 1 shows a range to be stamped or pressed to transfer in a positive electrode press step S3, a second solid electrolyte layer transfer step S4, an intermediate layer transfer step S5, a negative electrode side solid electrolyte layer transfer step S6, and an integration press step S8 to be described later.

The positive electrode sheet member 200 is an example of a “substrate sheet”, and is a sheet-like member obtained by laminating the positive electrode active material layer 41 on the positive electrode current collecting foil 42a constituting the positive electrode current collector layer 42. The positive electrode sheet member 200 is fed by a roller (not shown) and conveyed to continuously extend from a base end side to a terminal end in a production line of the solid-state battery 1.

The expander roll 110, the first positive electrode transfer roller 120, the peeling roller 130, the second positive electrode transfer roller 140, the intermediate layer transfer roller 150, the negative electrode transfer roller 160, and the negative electrode sheet member lamination roller 170 each include a pair of rotating bodies.

These rotating bodies are arranged in an order of the expander roll 110, the first positive electrode transfer roller 120, the peeling roller 130, the positive electrode press roll 180, the second positive electrode transfer roller 140, the negative electrode sheet member lamination roller 170, and the integration press roll 190 from an upstream side along a conveyance direction that is a direction in which the positive electrode sheet member 200 is conveyed (hereinafter simply referred to as the “conveyance direction”).

The intermediate layer transfer roller 150 and the negative electrode transfer roller 160 are disposed away from a conveyance line along which the positive electrode sheet member 200 is conveyed in the conveyance direction (hereinafter, simply referred to as the “conveyance line”), and perform transfer pressing for the intermediate layer 5 or the negative electrode side solid electrolyte layer SE3. Thereafter, as will be described later, the negative electrode layer 2 and the intermediate layer 5 to which the negative electrode side solid electrolyte layer SE3 is transferred are conveyed to an upper surface side or a lower surface side of the positive electrode sheet member 200, join the conveyance line of the positive electrode sheet member 200, and are laminated by the negative electrode sheet member lamination roller 170.

The first positive electrode transfer roller 120, the second positive electrode transfer roller 140, the intermediate layer transfer roller 150, and the negative electrode transfer roller 160 perform transfer pressing by passing a sheet such as a base material on a transfer receiving side and a sheet provided with a solid electrolyte layer to be transferred while sandwiching the sheets between a pair of rollers and pressing.

Specifically, the first positive electrode transfer roller 120 transfers the first solid electrolyte layer SE1 to the positive electrode sheet member 200 by sandwiching a transfer sheet 121, which is a sheet where the first solid electrolyte layer SE1 or the like is provided, between a pair of rollers and pressing. The first solid electrolyte layer SE1 is an example of a “transfer body”.

In the embodiment, as described above, the expander roll 110 is disposed upstream of the first positive electrode transfer roller 120. The expander roll 110 is configured to apply a tension to the transfer sheet 121 in a width direction orthogonal to the conveyance direction of the positive electrode sheet member 200 (hereinafter simply referred to as the “width direction”) before the first positive electrode transfer roller 120 transfers the first solid electrolyte layer SE1 to the positive electrode sheet member 200.

Here, a reason why the expander roll 110 is provided in the embodiment will be described. For example, as known in the related art, when the first solid electrolyte layer SE1 is transferred to the positive electrode sheet member 200 by the first positive electrode transfer roller 120 in a state where the expander roll 110 is not provided, the transfer may not be performed appropriately. In particular, since no tension is applied in the width direction, transfer accuracy of the first solid electrolyte layer SE1 may decrease. When the transfer accuracy decreases in this way, bonding accuracy between the first solid electrolyte layer SE1 and the positive electrode layer 4 (positive electrode active material layer 41) may also decrease. Therefore, in the embodiment, the expander roll 110 is provided to improve the transfer accuracy of the first solid electrolyte layer SE1.

FIG. 3 is an enlarged view showing a portion surrounded by a broken line in FIG. 2 in more detail. As shown here, the expander roll 110 applies the tension in the width direction as well as the conveyance direction to the transfer sheet 121 unwound from a transfer sheet roll body 122 around which the transfer sheet 121 is wound. Arrows shown in rollers and roll bodies in FIG. 3 indicate rotation directions of the rollers and the roll bodies.

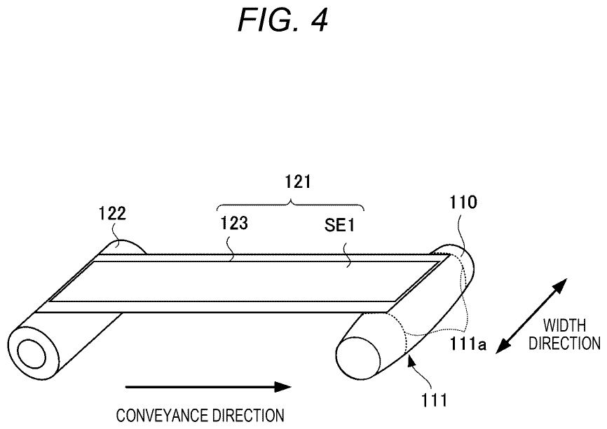

Specifically, as shown in FIG. 4, the expander roll 110 is a roll body that extends in the width direction, and a diameter on a central portion side is greater than diameters of both ends. In other words, the expander roll 110 has a so-called crown shape in which an outer diameter gradually decreases from the central portion side toward end sides. A cross section of the crown shape may be a tapered shape that is linear from the central portion side toward the end sides, or may be a curved shape that is curved from the central portion side toward the end sides.

With this shape, the transfer sheet 121 is pulled toward both ends, that is, the tension is applied thereto in the width direction. Regarding a tension in the conveyance direction, it can be assumed that a certain degree of tension is applied even when the expander roll 110 is not provided, but it is assumed that the tension in the conveyance direction is greater when the expander roll 110 is provided.

As shown in FIGS. 3 and 4, the transfer sheet 121 includes the first solid electrolyte layer SE1 and a base material sheet 123 provided with the first solid electrolyte layer SE1. The base material sheet 123 is peeled from the transferred first solid electrolyte layer SE1 by the peeling roller 130 to be described later, and is made of, for example, polyethylene terephthalate (PET). In FIG. 3, in the transfer sheet 121 unwound from the transfer sheet roll body 122, the first solid electrolyte layer SE1 is indicated by a solid line, and the peeled base material sheet 123 is indicated by a broken line.

The expander roll 110 in the embodiment has a positioning portion 111 for positioning the transfer sheet 121. In the example shown in FIG. 4, as an example of the positioning portion 111, an example is shown in which a guide groove 111a for guiding the transfer sheet 121 is formed. Since the transfer sheet 121 is guided by the guide groove 111a, movement of the transfer sheet 121 in the width direction can be restricted. The configuration of the positioning portion 111 may be another configuration as long as the transfer sheet 121 can be positioned in the width direction. For example, instead of the guide groove 111a, a pair of barrier portions may be formed in the width direction.

The transfer sheet 121 conveyed via the expander roll 110 is then transferred to the positive electrode sheet member 200 by the first positive electrode transfer roller 120. In order to accurately perform such transfer, it is preferable that the transfer sheet 121 and the positive electrode sheet member 200 are parallel during transfer pressing by the first positive electrode transfer roller 120. In the embodiment, as described above, since the expander roll 110 has the positioning portion 111 where the transfer sheet 121 is positioned, the transfer sheet 121 is in a state where the tension is applied in the width direction (as well as the conveyance direction), and the transfer sheet 121 and the positive electrode sheet member 200 can be brought into the desired parallel state.

As a premise, the expander roll 110 is provided with a motor (not shown) that can adjust an unwinding speed and the like of the transfer sheet 121. By controlling a rotation speed of the motor, it is possible to adjust a relative speed between the positive electrode sheet member 200 and the transfer sheet 121 moving in the conveyance direction at a predetermined speed.

In this way, the expander roll 110 not only has a function of applying the tension to the transfer sheet 121 in the width direction, but also has a function of making the transfer sheet 121 parallel to the positive electrode sheet member 200. In other words, it can be said that the expander roll 110 also has a function of adjusting an entry angle of the transfer sheet 121 with respect to the positive electrode sheet member 200 in order to establish the parallel state.

The peeling roller 130 is disposed downstream of the first positive electrode transfer roller 120. The peeling roller 130 peels the base material sheet 123 from the transfer sheet 121 where the first solid electrolyte layer SE1 is provided. Specifically, as shown in FIG. 3, the base material sheet 123 is peeled from the first solid electrolyte layer SE1 subjected to the transfer pressing. At this time, the peeling roller 130 also functions as a hold-down when peeling the base material sheet 123 from the first solid electrolyte layer SE1. The peeled base material sheet 123 is then wound by a base material roll body 131 that winds the base material sheet 123.

In this way, the tension is applied to the transfer sheet 121 unwound from the transfer sheet roll body 122 mainly in the width direction by the expander roll 110, and under this state, the first solid electrolyte layer SE1 is transferred to the positive electrode sheet member 200 by the first positive electrode transfer roller 120. Then, the base material sheet 123 is wound from the transferred first solid electrolyte layer SE1 by the base material roll body 131 via the peeling roller 130.

As shown in FIG. 3, the transfer sheet 121 is provided on two surface sides with the positive electrode sheet member 200 interposed therebetween so as to be vertically symmetric, and is configured to transfer the first solid electrolyte layer SE1 to both surfaces of the positive electrode sheet member 200. Accordingly, the first solid electrolyte layer SE1 can be simultaneously transferred to both surfaces of the positive electrode sheet member 200.

As shown in FIG. 2, the second positive electrode transfer roller 140 transfers the second solid electrolyte layer SE2 onto the positive electrode sheet member 200 to which the first solid electrolyte layer SE1 is transferred and pressed (stamped).

As shown in FIG. 5, the intermediate layer transfer roller 150 transfers the intermediate layer 5 to the negative electrode active material layer 21 laminated on the negative electrode current collecting foil 22a. Accordingly, the intermediate layer 5 is disposed between the negative electrode active material layer 21 and the negative electrode side solid electrolyte layer SE3.

As shown in FIG. 5, the negative electrode transfer roller 160 forms a negative electrode sheet member 210 by transferring the negative electrode side solid electrolyte layer SE3 onto the intermediate layer 5.

As shown in FIG. 2, the negative electrode sheet member lamination roller 170 conveys and laminates the negative electrode sheet member 210, to which the negative electrode side solid electrolyte layer SE3 is transferred, onto the positive electrode sheet member 200 to which the first solid electrolyte layer SE1 and the second solid electrolyte layer SE2 are transferred.

As shown in FIG. 2, each of the positive electrode press roll 180 and the integration press roll 190 is constituted by a pair of rotating rollers similarly to each transfer roller, and the positive electrode sheet member 200 where the solid electrolyte layers and the like are laminated according to each process is interposed between the pair of rollers, passed therethrough while being pressed, and thus densified. The positive electrode press roll 180, which is an example of a “press roll”, presses (stamps) the positive electrode sheet member 200 to which the first solid electrolyte layer SE1 is transferred. The integration press roll 190 presses (stamps) the positive electrode sheet member 200 and the negative electrode sheet member 210 in a laminated state to integrate the electrode 10. Accordingly, the positive electrode sheet member 200 and the negative electrode sheet member 210 are integrated, and at the same time, the first solid electrolyte layer SE1, the second solid electrolyte layer SE2, and the negative electrode side solid electrolyte layer SE3 are densified.

### Press Method

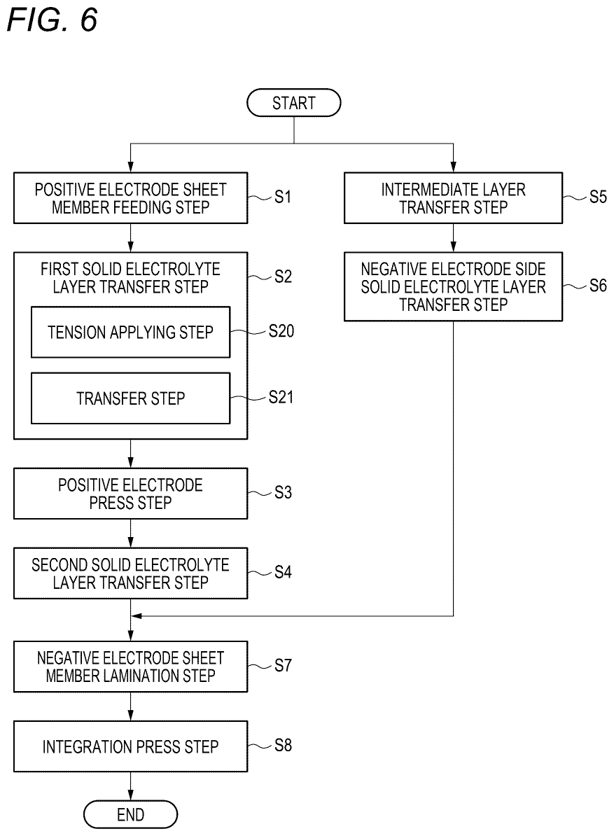

Next, a press method using the press device 100 for the solid-state battery 1 configured as described above will be described. FIG. 6 is a flowchart showing an example of the press method. The press method includes, as processes, a positive electrode sheet member feeding step S1, a first solid electrolyte layer transfer step S2, a positive electrode press step S3, a second solid electrolyte layer transfer step S4, an intermediate layer transfer step S5, a negative electrode side solid electrolyte layer transfer step S6, a negative electrode sheet member lamination step S7, and an integration press step S8. The first solid electrolyte layer transfer step S2 includes a tension applying step S20 and a transfer step S21.

The positive electrode sheet member feeding step S1 is a step of conveying and feeding the positive electrode sheet member 200 by a conveying roller (not shown). That is, the positive electrode sheet member 200 where the positive electrode active material is coated and laminated on the positive electrode current collecting foil 42a constituting the positive electrode current collector layer 42 is fed.

The first solid electrolyte layer transfer step S2 is a step of transferring the first solid electrolyte layer SE1 to the positive electrode sheet member 200 by the first positive electrode transfer roller 120. Specifically, in the first solid electrolyte layer transfer step S2, the tension applying step S20 and the transfer step S21 are executed.

The tension applying step S20 is a step of applying, by the expander roll 110 described above, the tension in the width direction to the transfer sheet 121 unwound from the transfer sheet roll body 122. That is, since the diameter on the central portion side of the expander roll 110 is greater than the diameters of both ends, the transfer sheet 121 is pulled toward both end sides of the expander roll 110, and the tension is applied in the width direction. As described above, the transfer sheet 121 is positioned in the width direction by the guide groove 111a formed in the expander roll 110, accordingly, the tension is applied in the width direction and the transfer sheet 121 and the positive electrode sheet member 200 become parallel to each other, and the transfer step S21 to be described later is performed while maintaining this parallel state.

The transfer step S21 is a step of transferring the first solid electrolyte layer SE1 on the transfer sheet 121, to which the tension is applied, to the positive electrode sheet member 200. Specifically, a slurry constituting the first solid electrolyte layer SE1 is passed on the positive electrode sheet member 200 while being pressed by a pair of first positive electrode transfer rollers 120 to perform transfer pressing. A pressure at this time is, for example, 50 MPa to 500 MPa at ambient temperature (for example, 10° C. to 35° C.). The pressure is preferably 100 MPa at 25° C.

After the transfer step, the base material sheet 123 is peeled, by the peeling roller 130, from the first solid electrolyte layer SE1 subjected to the transfer pressing. The peeled base material sheet 123 is then wound by the base material roll body 131 that winds the base material sheet 123.

The positive electrode press step S3 is a step of pressing (stamping), by the positive electrode press roll 180, the positive electrode sheet member 200 to which the first solid electrolyte layer SE1 is transferred. The positive electrode is densified by the positive electrode press step S3. A pressing (stamping) pressure for densifying is, for example, about 800 MPa to 1200 MPa at 25° C. to 100° C. A densified laminate of the positive electrode sheet member 200 and the first solid electrolyte layer SE1 is conveyed downstream in the conveyance line.

The second solid electrolyte layer transfer step S4 is a step of transferring, by the second positive electrode transfer roller 140, the second solid electrolyte layer SE2 onto the positive electrode sheet member 200 to which the first solid electrolyte layer SE1 is transferred and pressed (stamped) after the positive electrode press step S3. Specifically, in the second solid electrolyte layer transfer step S4, the second solid electrolyte layer SE2 is positioned to be disposed within a range guided by a guide roller (not shown) on the positive electrode sheet member 200 to which the first solid electrolyte layer SE1 is transferred. Then, a slurry constituting the second solid electrolyte layer SE2 is passed on the positive electrode sheet member 200 while being pressed by the second positive electrode transfer roller 140 as a transfer roller to perform transfer pressing. A pressure at this time is, for example, 50 MPa to 500 MPa at ambient temperature (for example, 10° C. to 35° C.). In this way, the positive electrode sheet member 200 is pressed twice or more. The pressure is preferably 150 MPa at 25° C.

Meanwhile, the negative electrode sheet member 210 is prepared at a position away from the conveyance line. First, as shown on an upper side in FIG. 5, the intermediate layer 5 is transferred, by the intermediate layer transfer roller 150, to the negative electrode active material layer 21 laminated on the negative electrode current collecting foil 22a (intermediate layer transfer step S5). Then, as shown on a lower side in FIG. 5, the negative electrode sheet member 210 is formed by transferring the negative electrode side solid electrolyte layer SE3 onto the intermediate layer 5 by the negative electrode transfer roller 160 (negative electrode side solid electrolyte layer transfer step S6). Accordingly, the intermediate layer 5 is disposed between the negative electrode active material layer 21 and the negative electrode side solid electrolyte layer SE3. In the embodiment, the negative electrode sheet member 210 includes a laminate of the negative electrode current collecting foil 22a, the negative electrode active material layer 21, the intermediate layer 5, and the negative electrode side solid electrolyte layer SE3, and alternatively, the negative electrode active material layer 21 and the intermediate layer 5 may not be contained.

In the intermediate layer transfer step S5, a slurry constituting the intermediate layer 5 is positioned to be disposed within a range guided by a guide roller (not shown) on the negative electrode active material layer 21. Then, the intermediate layer 5 is pressed and passed on the negative electrode active material layer 21 by the intermediate layer transfer roller 150 as a transfer roller to perform intermediate layer transfer pressing for transferring the intermediate layer 5 to the negative electrode active material layer 21. A pressure at this time is, for example, 50 MPa to 800 MPa at ambient temperature (for example, 10° C. to 35°C.). More preferably, the pressure is in a range of 300 MPa or more and 800 MPa or less at 25° C.

In the negative electrode side solid electrolyte layer transfer step S6, a slurry constituting the negative electrode side solid electrolyte layer SE3 is positioned to be disposed within a range guided by a guide roller (not shown) on the intermediate layer 5. Then, the negative electrode side solid electrolyte layer SE3 is pressed and passed on the intermediate layer 5 by the negative electrode transfer roller 160 as a transfer roller, and negative electrode active material layer transfer pressing for transferring the negative electrode side solid electrolyte layer SE3 to the intermediate layer 5 is performed. A pressure at this time is, for example, 600 MPa to 800 MPa at ambient temperature (for example, 10° C. to 35° C.).

Regarding the pressure, the pressure in the positive electrode press step S3 is not only a maximum press value for pressing the positive electrode sheet member 200 but also a maximum press pressure value in the entire method of the press device. The positive electrode sheet member 200 is pressed (stamped) at a high pressure in order to increase energy density and densify the electrode. The maximum pressure value in the positive electrode press step S3 is equal to or greater than a maximum pressure value for pressing (stamping) the negative electrode sheet member 210.

The pressure at the time of transfer in the first solid electrolyte layer transfer step S2 and the second solid electrolyte layer transfer step S4 is also smaller than the pressure in the positive electrode press step S3. The pressure at the time of transfer in the first solid electrolyte layer transfer step S2 and the second solid electrolyte layer transfer step S4 is also smaller than the press pressure in the negative electrode side solid electrolyte layer transfer step S6.

Since the first solid electrolyte layer SE1 and the second solid electrolyte layer SE2 contain a relatively large amount of binder, the pressure during transfer can be reduced. In addition, by setting the pressure for transfer as low as possible, elongation of the first solid electrolyte layer SE1 and the second solid electrolyte layer SE2 due to transfer pressing can be reduced. Therefore, it is possible to leave room for the first solid electrolyte layer SE1 and the second solid electrolyte layer SE2 to extend in the subsequent integration press step S8 and the like, and the first solid electrolyte layer SE1 can be extended to follow the positive electrode layer 4. Thereby, adhesion between the first solid electrolyte layer SE1 and the positive electrode active material layer 41 can be improved.

After the negative electrode side solid electrolyte layer transfer step S6, the formed negative electrode sheet member 210 is cut by a cutter in a state of being supported by a payout roll that feeds the member transferred in the negative electrode side solid electrolyte layer transfer step S6. The negative electrode sheet member 210 is cut to a design dimension of the negative electrode layer 2 of the solid-state battery 1.

As shown in FIGS. 2 and 6, the negative electrode sheet member 210 cut to the design dimension is conveyed to the positive electrode sheet member 200 to join the conveyance line of the positive electrode sheet member 200, and is laminated on the positive electrode sheet member 200. At this time, before the integration press step S8 to be described later, on a surface of the positive electrode sheet member 200 facing the negative electrode side solid electrolyte layer SE3, the first solid electrolyte layer SE1 is provided on a lower layer side, and the second solid electrolyte layer SE2 is provided thereon. Then, the negative electrode sheet member 210 is disposed on the positive electrode sheet member 200 in a cut state.

Specifically, in the negative electrode sheet member lamination step S7, the negative electrode sheet member 210 to which the negative electrode side solid electrolyte layer SE3 is transferred is conveyed and laminated, by the negative electrode sheet member lamination roller 170, onto the positive electrode sheet member 200 to which the first solid electrolyte layer SE1 and the second solid electrolyte layer SE2 are transferred. In the negative electrode sheet member lamination step S7, the negative electrode sheet member 210 cut to the design dimension is positioned on the positive electrode sheet member 200, to which the first solid electrolyte layer SE1 and the second solid electrolyte layer SE2 are transferred, so as to be disposed within a range guided by a guide roller (not shown).

In this way, in a state where the positive electrode sheet member 200 and the negative electrode sheet member 210 are laminated, the electrode 10 is pressed by the integration press roll 190 so as to be integrated (integration press step S8). In a state immediately before the integration press step S8, regarding thicknesses of the negative electrode sheet member 210 and the positive electrode sheet member 200 in the lamination direction, the thickness of the positive electrode sheet member 200 is greater than the thickness of the negative electrode sheet member 210. A pressure at this time is, for example, about 500 MPa to 900 MPa at 25° C. to 100° C. Through the integration press step S8, the positive electrode sheet member 200 and the negative electrode sheet member 210 are integrated, and at the same time, the first solid electrolyte layer SE1, the second solid electrolyte layer SE2, and the negative electrode side solid electrolyte layer SE3 are densified. When the press pressures in the integration press step S8 and the positive electrode press step S3 are compared, the press pressure in the positive electrode press step S3 is higher than the press pressure in the integration press step S8.

After the integration press step S8, the formed electrode 10 is cut by a rotary cutter.

The processes of transferring the first solid electrolyte layer SE1 in the first solid electrolyte layer transfer step S2, pressing the positive electrode sheet member 200 in the positive electrode press step S3, transferring the second solid electrolyte layer SE2 in the second solid electrolyte layer transfer step S4, laminating the negative electrode sheet member 210 before integration in the negative electrode sheet member lamination step S7, and the integration pressing in the integration press step S8 are performed on both surfaces of the positive electrode sheet member 200 fed in the positive electrode sheet member feeding step S1. Accordingly, as shown in FIG. 1, the solid-state battery 1 where the layers are symmetrically laminated on both upper and lower surfaces of the positive electrode sheet member 200 interposed therebetween is obtained.

In this way, in the embodiment, by providing the expander roll 110, the tension in the width direction can be applied to the transfer sheet 121, thus the first solid electrolyte layer SE1 can be transferred to the positive electrode sheet member 200 in a state where the tension in the width direction is applied, and as a result, transfer accuracy of the first solid electrolyte layer SE1 can be improved. In other words, the first solid electrolyte layer SE1 can be accurately transferred to the positive electrode layer 4, and as a result, bonding accuracy between the first solid electrolyte layer SE1 and the positive electrode layer 4 (positive electrode active material layer 41) can be improved.

Although the embodiment has been described above with reference to the drawings, it is needless to say that the present invention is not limited to the embodiment. It is apparent that those skilled in the art can conceive of various modifications and changes within the scope described in the claims, and it is understood that such modifications and changes naturally fall within the technical scope of the present invention. In addition, the components in the above embodiment may be freely combined without departing from the gist of the invention.

For example, in the above-described embodiment, various solid electrolyte layers are laminated on both surfaces of the positive electrode sheet member 200, and alternatively, the lamination may be performed on only one surface.

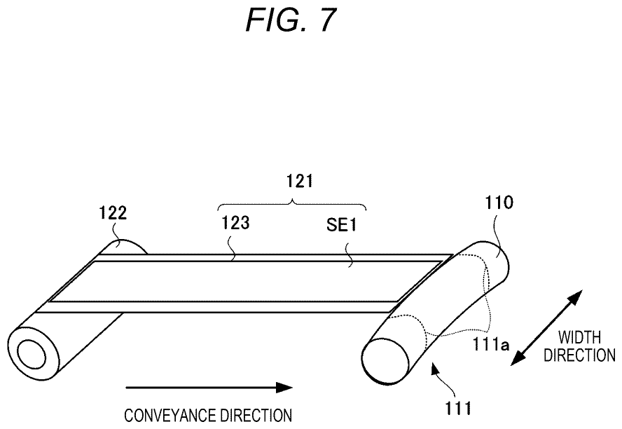

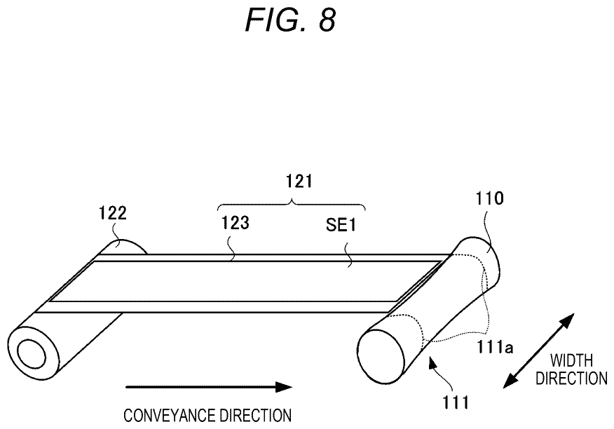

A shape of the expander roll 110 may be as shown in FIGS. 7 and 8 in addition to the example shown in FIG. 4. For example, as shown in FIG. 7, the expander roll 110 may be formed by bending a straight roll to be convex on the central portion side with respect to the transfer sheet 121. In addition, for example, as shown in FIG. 8, the expander roll 110 may be configured such that the diameter on the central portion side is smaller than the diameters of both ends. That is, contrary to the example shown in FIG. 4, the expander roll 110 may have a shape in which the outer diameter gradually decreases from the end sides toward the central portion side.

In the present specification, at least the following matters are described. Although corresponding components in the embodiment described above are shown in parentheses, the present invention is not limited thereto.

(1 ) A press device (press device 100) configured to transfer a transfer body (first solid electrolyte layer SE1) to a substrate sheet (positive electrode sheet member 200), the press device including:
a transfer sheet roll body (transfer sheet roll body 122) around which a transfer sheet (transfer sheet 121) including the transfer body is wound;
a transfer roller (first positive electrode transfer roller 120) configured to transfer the transfer body to the substrate sheet; and
an expander roll (expander roll 110) configured to apply a tension to the transfer sheet, in which
the expander roll is disposed upstream of the transfer roller in a conveyance direction of the substrate sheet, and applies the tension to the transfer sheet in a width direction.

According to (1), since the tension in the width direction is applied to the transfer sheet, the transfer body can be transferred to the substrate sheet in a state where the tension in the width direction is applied, and as a result, transfer accuracy of the transfer body can be improved.

(2 ) The press device according to (1), in which
the transfer body is a solid electrolyte layer (first solid electrolyte layer SE1), and
the substrate sheet is a positive electrode sheet member (positive electrode sheet member 200).

According to (2), transfer accuracy of the first solid electrolyte layer to the positive electrode sheet member can be improved.

(3) The press device according to (1) or (2), in which
the expander roll has a larger diameter on a central portion side than diameters on both end sides, or has larger diameters on both end sides than the diameter on the central portion side, in a direction orthogonal to the conveyance direction of the substrate sheet.

According to (3), since the diameter on the central portion side is greater than the diameters on the both end sides or the diameters on the both end sides are larger than the diameter on the central portion side, the transfer sheet is pulled in the width direction orthogonal to the conveyance direction, and thus the transfer body provided on the transfer sheet can be transferred in a state where desired tension is applied.

(4) The press device according to (1) or (2), in which
the expander roll has a positioning portion (positioning portion 111) for positioning the transfer sheet.

According to (4), since the positioning portion positions the transfer sheet in the width direction, it is possible to restrict positional displacement of the transfer sheet in the width direction.

(5 ) The press device according to (1) or (2), in which
the transfer sheets are provided on both surface sides of the substrate sheet interposed between the transfer sheets, and
the transfer body is transferred to each of both surfaces of the substrate sheet.

According to (5), the transfer body can be simultaneously transferred to both surfaces of the substrate sheet.

(6) The press device according to (4), in which
the expander roll is configured such that the transfer sheet and the substrate sheet are caused to be parallel by the positioning portion.

According to (6), since the transfer sheet is positioned by the positioning portion and is brought into a state where the tension is applied, the transfer sheet can be parallel to the substrate sheet, and by transferring in such a parallel state, transfer accuracy can be improved, for example, as compared to a case of transferring in a non-parallel state.

(7 ) The press device according to (1) or (2), in which
the transfer sheet includes the transfer body and a base material sheet (base material sheet 123) where the transfer body is provided, and
a peeling roller (peeling roller 130) that peels the base material sheet from the transfer body transferred to the substrate sheet is disposed downstream of the transfer roller in the conveyance direction of the substrate sheet.

According to (7), after the transfer body is transferred to the substrate sheet, the base material sheet can be peeled from the transfer body. In addition, since the tension in the width direction is applied to the transfer sheet, for example, as compared to a case where the tension in the width direction is not applied, the base material sheet can be easily peeled.

(8) The press device according to (7), further including:
a press roll (positive electrode press roll 180) configured to press, at a high pressure, the substrate sheet to which the transfer body is transferred, in which
the press roll is disposed downstream of the peeling roller.

According to (8), the transfer body and the substrate sheet can be densified by pressing at a high pressure by the press roll.

(9 ) A press method of transferring a transfer body (first solid electrolyte layer SE1) to a substrate sheet (positive electrode sheet member 200), the press method including:
a tension applying step (tension applying step S20) of applying a tension, in a width direction orthogonal to a conveyance direction, to a transfer sheet unwound from a transfer sheet roll body (transfer sheet roll body 122);
a transfer step (transfer step S21) of transferring the transfer body, in a state where the tension is applied, to the substrate sheet; and
a press step (positive electrode press step S3) of pressing the substrate sheet to which the transfer sheet is transferred at a higher pressure than that in the transfer step.

According to (9), since the tension in the width direction is applied to the transfer sheet, the transfer body can be transferred to the substrate sheet in a state where the tension in the width direction is applied, and as a result, transfer accuracy of the transfer body can be improved.

What is claimed is:

1. A press device configured to transfer a transfer body to a substrate sheet, the press device comprising:
a transfer sheet roll body around which a transfer sheet including the transfer body is wound;
a transfer roller configured to transfer the transfer body to the substrate sheet; and
an expander roll configured to apply a tension to the transfer sheet, wherein
the expander roll is disposed upstream of the transfer roller in a conveyance direction of the substrate sheet, and applies the tension to the transfer sheet in a width direction.

2. The press device according to claim 1, wherein
the transfer body is a solid electrolyte layer, and
the substrate sheet is a positive electrode sheet member.

3. The press device according to claim 1, wherein
the expander roll has a larger diameter on a central portion side than diameters on both end sides, or has larger diameters on both end sides than the diameter on the central portion side, in a direction orthogonal to the conveyance direction of the substrate sheet.

4. The press device according to claim 1, wherein
the expander roll has a positioning portion for positioning the transfer sheet.

5. The press device according to claim 1, wherein
the transfer sheets are provided on both surface sides of the substrate sheet interposed between the transfer sheets, and
the transfer body is transferred to each of both surfaces of the substrate sheet.

6. The press device according to claim 4, wherein
the expander roll is configured such that the transfer sheet and the substrate sheet are caused to be parallel by the positioning portion.

7. The press device according to claim 1, wherein
the transfer sheet includes the transfer body and a base material sheet where the transfer body is provided, and
a peeling roller that peels the base material sheet from the transfer body transferred to the substrate sheet is disposed downstream of the transfer roller in the conveyance direction of the substrate sheet.

8. The press device according to claim 7, further comprising:
a press roll configured to press, at a high pressure, the substrate sheet to which the transfer body is transferred, wherein
the press roll is disposed downstream of the peeling roller.

9. A press method of transferring a transfer body to a substrate sheet, the press method comprising:
applying a tension, in a width direction orthogonal to a conveyance direction, to a transfer sheet unwound from a transfer sheet roll body;
transferring the transfer body, in a state where the tension is applied, to the substrate sheet; and
pressing the substrate sheet to which the transfer sheet is transferred at a higher pressure than that in the transferring the transfer body.
